(19) United States
(12) Patent Application Publication
(10) Pub. No.: US 2016/0171735 A1
(43) Pub. Date: Jun. 16, 2016

(54) COMPUTING DEVICE AND METHOD FOR JOINING POINT CLOUDS

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: XIN-YUAN WU, Shenzhen (CN); CHIH-KUANG CHANG, New Taipei (TW); PENG XIE, Shenzhen (CN)

(21) Appl. No.: 14/694,606

(22) Filed: Apr. 23, 2015

(30) Foreign Application Priority Data
Dec. 16, 2014 (CN) 201410772019.8

(51) Int. Cl. G06T 11/60; G06T 11/00; G09G 5/377

(52) U.S. Cl. CPC G06T 11/60; G09G 5/377; G06T 11/001; G09G 2340/12

(57) ABSTRACT

A computing device and a method joins point cloud of an object. Two sets of initial corresponding points are obtained from two groups of point cloud. Abnormal points in the two sets of initial corresponding points are deleted to obtain two sets of remaining corresponding points. The method calculates an objective function and a least square solution of the two sets of remaining corresponding points and converts a first set of remaining corresponding points based on the least square solution. The converted first set of remaining correspondence points is joined with a second set of remaining correspondence points to form a group of joined point cloud when a precision of the objective function is within the preset precision value.

### CROSS-REFERENCE TO RELATED APPLICATIONS

This application claims priority to Chinese Patent Application No. 201410772019.8 filed on Dec. 16, 2014, the contents of which are incorporated by reference herein.

### FIELD

The subject matter herein generally relates to point clouds technology, and particularly to a computing device and a method for joining point clouds of an object.

### BACKGROUND

A measurement device can measure a plurality of points to generate groups of incomplete point cloud by scanning a surface of an object (e.g., a component of a mobile phone). The groups of incomplete point cloud can be joined to generate a complete group of point cloud relating to the object. However, generating a single complete group of point cloud comprising all the groups is very complicated.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of a computing device.

FIG. 2 is a flowchart of an example embodiment of a method for joining point clouds.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules can be embedded in firmware, such as in an erasable programmable read only memory (EPROM). The modules described herein can be implemented as either software and/or computing modules and can be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series, and the like.

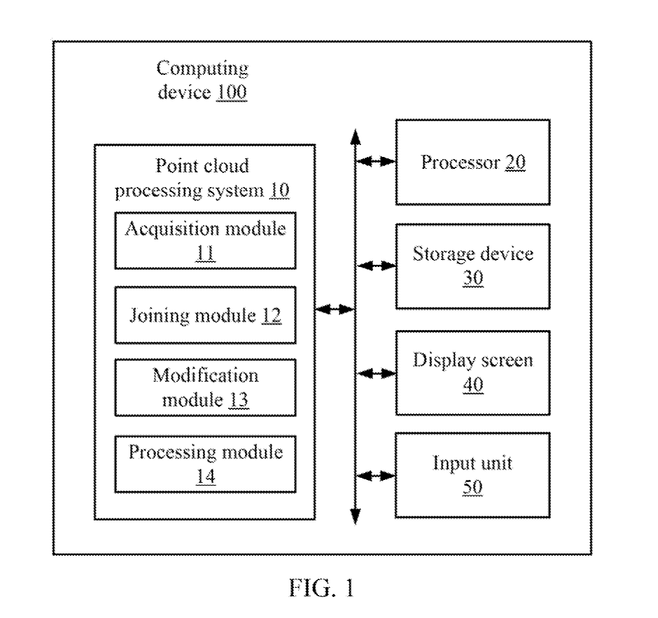

FIG. 1 illustrates a block diagram of an example embodiment of a computing device 100. In at least one embodiment, the computing device 100 can be, but is not limited to, a tablet computer, a server, a personal computer, a programmable logic controller (PLC), a measurement machine (e.g., a computerized numerical control (CNC) machine) or any other electronic device. FIG. 1 illustrates only one example of the computing device 100, and other examples can comprise more or fewer components than those shown in the embodiment, or have a different configuration of the various components.

In at least one embodiment, as shown in FIG. 1, the computing device 100 can include, but is not limited to having, a point cloud joining system 10, at least one processor 20, a storage device 30, a display screen 40, and an input unit 50. The at least one processor 20 executes one or more computerized codes and other applications of the computing device 100 to provide functions of the point cloud joining system 10. The storage device 30 can be an internal storage device, such as a random access memory (RAM) for temporary storage of information, and/or a read only memory (ROM) for permanent storage of information. The storage device 30 can also be an external storage device, such as an external hard disk, a storage card, or a data storage medium. The display screen 40 can display data of the computing device 100. The input unit 50 can be a keyboard or a mouse for receiving user input.

In at least one embodiment, the point cloud joining system 10 can include, but is not limited to having, an acquisition module 11, a joining module 12, a modification module 13, and a processing module 14. The modules 11-14 can include computerized instructions in the form of one or more computer-readable programs that can be stored in a non-transitory computer-readable medium, such as the storage device 30, and be executed by the at least one processor 20 of the computing device 100.

The acquisition module 11 acquires a first group of point cloud and a second group of point cloud, both relating to an object, from the storage device 30. In at least one embodiment, each group of point cloud can be a set of points represent the external surface of the object. The object may be, but is not limited to, a component (e.g., a shell) of an electronic device (e.g., a mobile phone). In at least one embodiment, each group of point cloud includes data, but is not limited to, coordinates of each point in the point cloud, a designation of each point in the point cloud, and a total quantity of the points in the point cloud.

In at least one embodiment, the storage device 30 can store a plurality of groups of point cloud relating to one object which can be integrated to form a single and complete group of point cloud relating to the object. The acquisition module 11 first selects two groups of point cloud requiring to be joined. After the first group of point cloud and the second group of point cloud are joined completely, the acquisition module 11 selects and adds another group of point cloud in the storage device 30, until all groups of point cloud of the object have been joined to form the single and complete group of point cloud.

The acquisition module 11 further predetermines a preset precision value. In at least one embodiment, the preset precision value can be predetermined according to user input. For example, a user can input the preset precision value using the input device 50 according to a precision requirement of joining the first and second groups of point cloud. In at least one embodiment, the preset precision value also can be determined according to an average distance between all points in the respective first and second group of point cloud. For example, the preset precision value can be set as 0.005 millimeters when the average distance between all points is 0.15 millimeters.

The joining module 12 obtains a first set of initial corresponding points from the first group of point cloud and obtains a second set of initial corresponding points from the second group of point cloud by initially joining the first group of point cloud and the second group of point cloud based on a feature point matching method. In at least one embodiment, the feature point matching method requires corresponding feature points to be acquired from the first group of point cloud and from the second group of point cloud by using a corner detection algorithm or by extracting boundary characteristic points, and a transition matrix is calculated according to the corresponding feature points by using singular values, by using quaternion, or by using singular value decomposition. The first set of initial corresponding points and the second set of initial corresponding points are obtained according to the transition matrix and the corresponding feature points.

In order to initially join the first group of point cloud and the second group of point cloud quickly, the joining module 12 can filter the first group of point cloud and the second group of point cloud by removing points representing noise before joining the first and second groups of point cloud.

The modification module 13 obtains a first set of remaining corresponding points and a second set of remaining corresponding points by deleting abnormal points (as hereinafter defined) in the first set of initial corresponding points and in the second set of initial corresponding points, according to a preset rule. In at least one embodiment, the preset rule includes calculating a curvature variation and an angle of normal vectors between each pair of corresponding points in the first set of initial corresponding points and in the second set of initial corresponding points, and deleting a selected pair of corresponding points from the first set of initial corresponding points and the second set of initial corresponding points when a curvature variation between the selected pair of corresponding points is larger than a preset threshold value and an angle of normal vectors between the selected pair of corresponding points is less than a preset angle, a pair of points showing one or other of these attributes being herein characterized as “abnormal”. The preset threshold value and the preset angle are determined according to the average distance between all points in the respective first and second group of point cloud. For example, the preset angle can be preset as 45 degrees.

In at least one embodiment, a curvature and a normal vector of each feature point of the pair of corresponding points are calculated based on a covariance matrix of proximal points of the feature point. For example, if a feature point of the corresponding points is represented as “qᵢ”, proximal points of “qᵢ” is represented as “Qᵢ”, and “Qᵢ” includes a number of “n” points. A centre of mass of “Qᵢ” is represented as

$$“ {\overline{q}}_{i} = \frac{1}{\vert {Q}_{i} \vert} {\sum }_{{q}_{j} ∈ {Q}_{i}}^{ } {q}_{j} ” ,$$

and a covariance matrix of “Qᵢ” is represented as “D=[q₁−q̅ᵢ̅ . . . qⱼ_{ₙ}−q̅ᵢ̅]*[q₁−q̅ᵢ̅ . . . qⱼ_{ₙ}−q̅ᵢ̅]^{T}”. The modification module 13 determines that a normal vector of “qᵢ” is an eigenvector of a smallest eigenvalue of “D”. If the normal vector of “qᵢ” is represented as “nⱼ”, a variance matrix of “nⱼ” is represented as

$$“ {D}^{′} = {\sum }_{j ∈ {Q}_{i}} {n}_{j} * {n}_{j}^{T} ” .$$

The modification module 13 determines that a curvature of “qᵢ” is a smallest eigenvalue of “D′”. The modification module 13 calculates the curvature variation between a pair of corresponding points according to the curvature of each feature point of the pair of corresponding points, and calculates the angle of normal vectors between each pair of corresponding points according to the normal vector of each feature point of the pair of corresponding points.

The processing module 14 calculates an objective function of the first set of remaining corresponding points and the second set of remaining corresponding points. In at least one embodiment, the processing module 14 calculates distances between the first set of remaining corresponding points and the second set of remaining corresponding points, and determines a standard deviation from the distances as the objective function. For example, if the first set of remaining corresponding points is represented as “P”, and the second set of remaining corresponding points is represented as “Q”, each set of “P” and “Q” includes a number of “n” points, and the processing module 14 determines a standard deviation of

$$“ {f}_{i} = sqrt ( {\sum }_{j = 1}^{n} ( \vert {P}_{j} - {Q}_{j} \vert \hat{} 2 ) ) ”$$

as the objective function, wherein the number “i” is an integer starting from “1.”

The processing module 14 calculates a least square solution of the first set of remaining corresponding points and the second set of remaining corresponding points, and converts the first set of remaining corresponding points based on the calculated least square solution. In at least one embodiment, the processing module 14 calculates a conversion relationship between the first set of remaining corresponding points and the second set of remaining corresponding points by using singular values or by using singular value decomposition, and sets the conversion relationship as the least square solution. In at least one embodiment, the processing module 14 obtains the converted first set of remaining corresponding points by multiplying the least square solution and the first set of remaining corresponding points.

The processing module 14 further determines whether a precision of the objective function is less than the preset precision value. In at least one embodiment, the processing module 14 determines that the precision of the objective function is to be represented as “k=|ƒᵢ−ƒᵢ₋₁|”, wherein “f₀” is preset as “0.”

If the precision of the objective function is less than the preset precision value, the processing module 14 further joins the converted first set of remaining corresponding points with the second set of remaining corresponding points to form a group of joined point cloud, and outputs the joined point cloud to be displayed on the display screen 40. The joined point cloud is a single coherent point cloud relating to the object. If the precision of the objective function is greater than or equal to the preset precision value, the processing module 14 further sets the converted first set of remaining corresponding points and the second set of remaining corresponding points as the first set of initial corresponding points and the second set of initial corresponding points, and executes the iterative method to continuously delete abnormal points from the first set of initial corresponding points and the second set of initial corresponding points, and to recalculate the precision of the objective function until the precision of the objective function is within the required preset precision value.

In at least one embodiment, before setting the converted first set of remaining corresponding points and the second set of remaining corresponding points as the first set of initial corresponding points and the second set of initial corresponding points, the processing module 14 adds one to an iteration number, and determines whether the iteration number is greater than a preset value. The preset value is used for setting a number that the first set of remaining corresponding points can be converted. The preset value is user-determined or predetermined, for example, can be set as 10. If the iteration number is less than or equal to the preset value, the processing module 14 sets the converted first set of remaining corresponding points and the second set of remaining corresponding points as the first set of initial corresponding points and the second set of initial corresponding points, and continuously executes the iterative method to delete abnormal points from the first set of initial corresponding points and the second set of initial corresponding points. If the iteration number is greater than the preset value, the processing module 14 at that stage joins the converted first set of remaining corresponding points with the second set of remaining corresponding points to form the joined point cloud.

In at least one embodiment, before outputting the joined point cloud, the processing module 14 can simplify an overlap area of the joined point cloud where the converted first set of remaining corresponding points does overlap with the second set of remaining corresponding points by executing preset simplification methods, and render the overlap area of the joined point cloud seamless, by executing preset smoothing methods.

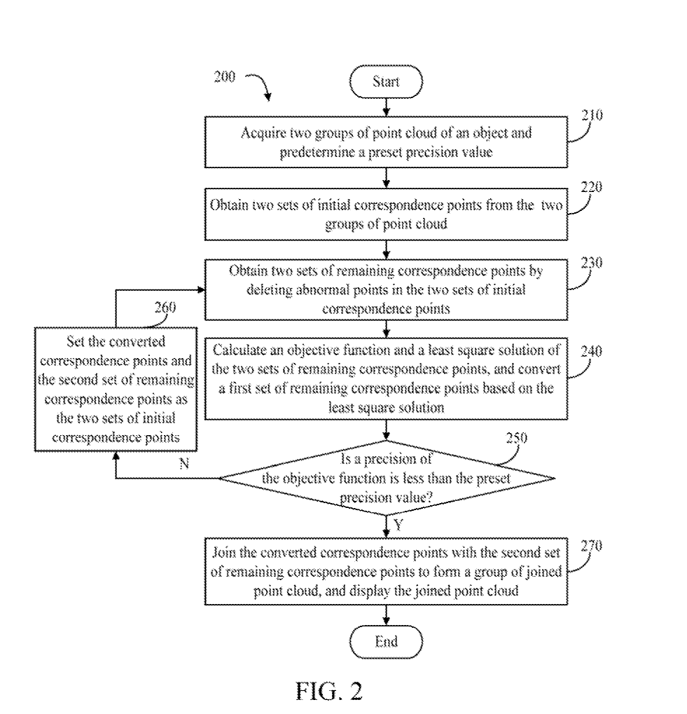

FIG. 2 illustrates a flowchart of an example embodiment of a method for joining point clouds. In an example embodiment, the method is performed by execution of computer-readable software program codes or instructions by at least one processor of a computing device.

Referring to FIG. 2, a flowchart is presented in accordance with an example embodiment. The method 200 is provided by way of example, as there are a variety of ways to carry out the method. The method 200 described below can be carried out using the configurations illustrated in FIG. 1, for example, and various elements of the figure are referenced in explaining example method 200. Each block shown in FIG. 2 represents one or more processes, methods, or subroutines, carried out in the method 200. Furthermore, the illustrated order of blocks is illustrative only and the order of the blocks can be changed. Additional blocks can be added or fewer blocks can be utilized without departing from this disclosure. The example method 200 can begin at block 210.

At block 210, an acquisition module acquires a first group of point cloud and a second group of point cloud, both relating to an object, from a storage device of the computing device, and predetermines a preset precision value. In at least one embodiment, each group of point cloud can be a set of points represent the external surface of the object. The object may be, but is not limited to, a component (e.g., a shell) of an electronic device (e.g., a mobile phone). In at least one embodiment, each group of point cloud includes data, but is not limited to, coordinates of each point in the point cloud, a designation of each point in the point cloud, and a total quantity of the points in the point cloud.

In at least one embodiment, the storage device can store a plurality of groups of point cloud relating to one object which can be integrated to form a single and complete group of point cloud relating to the object. The acquisition module first selects two groups of point cloud requiring to be joined. After the first group of point cloud and the second group of point cloud are joined completely, the acquisition module selects and adds another group of point cloud in the storage device, until all groups of point cloud of the object have been joined to form the single and complete group of point cloud. In at least one embodiment, the preset precision value can be predetermined according to user input, or be determined according to an average distance between all points in the respective first and second group of point cloud.

At block 220, a joining module obtains a first set of initial corresponding points from the first group of point cloud and obtains a second set of initial corresponding points from the second group of point cloud by initially joining the first group of point cloud and the second group of point cloud based on a feature point matching method. In at least one embodiment, the feature point matching method requires corresponding feature points to be acquired from the first group of point cloud and from the second group of point cloud by using a corner detection algorithm or by extracting boundary characteristic points, and a transition matrix is calculated according to the corresponding feature points by using singular values, by using quaternion, or by using singular value decomposition. The first set of initial corresponding points and the second set of initial corresponding points are obtained according to the transition matrix and the corresponding feature points.

At block 230, a modification module obtains a first set of remaining corresponding points and a second set of remaining corresponding points by deleting abnormal points (as hereinafter defined) in the first set of initial corresponding points and in the second set of initial corresponding points, according to a preset rule. In at least one embodiment, the preset rule includes calculating a curvature variation and an angle of normal vectors between each pair of corresponding points in the first set of initial corresponding points and in the second set of initial corresponding points, and deleting a selected pair of corresponding points from the first set of initial corresponding points and the second set of initial corresponding points when a curvature variation between the selected pair of corresponding points is larger than a preset threshold value and an angle of normal vectors between the selected pair of corresponding points is less than a preset angle, a pair of points showing one or other of these attributes being herein characterized as “abnormal”. The preset threshold value and the preset angle are determined according to the average distance between all points in the respective first and second group of point cloud. For example, the preset angle can be preset as 45 degrees.

In at least one embodiment, a curvature and a normal vector of each feature point of the pair of corresponding points are calculated based on a covariance matrix of proximal points of the feature point. For example, if a feature point of the corresponding points is represented as “qᵢ”, proximal points of “qᵢ” is represented as “Qᵢ”, and “Qᵢ” includes a number of “n” points. A centre of mass of “Qᵢ” is represented as

$$“ {\overline{q}}_{i} = \frac{1}{\vert {Q}_{i} \vert} {\sum }_{{q}_{j} ∈ {Q}_{i}}^{ } {q}_{j} ” ,$$

and a covariance matrix of “Qᵢ” is represented as “D=[q₁−q̅ᵢ̅ . . . qⱼ_{ₙ}−q̅ᵢ̅]*[q₁−q̅ᵢ̅ . . . qⱼ_{ₙ}−q̅ᵢ̅]^{T}”. The modification module 13 determines that a normal vector of “qᵢ” is an eigenvector of a smallest eigenvalue of “D”. If the normal vector of “qᵢ” is represented as “nⱼ”, a variance matrix of “nⱼ” is represented as

$$“ {D}^{′} = {\sum }_{j ∈ {Q}_{i}}^{ } {n}_{j} * {n}_{j}^{T} ” .$$

The modification module determines that a curvature of “qᵢ” is a smallest eigenvalue of “D′”. The modification module calculates the curvature variation between a pair of corresponding points according to the curvature of each feature point of the pair of corresponding points, and calculates the angle of normal vectors between the pair of corresponding points according to the normal vector of each feature point of the pair of corresponding points.

At block 240, a processing module calculates an objective function of the first set of remaining corresponding points and the second set of remaining corresponding points, calculates a least square solution of the first set of remaining corresponding points and the second set of remaining corresponding points, and converts the first set of remaining corresponding points based on the calculated least square solution.

In at least one embodiment, the processing module calculates distances between the first set of remaining corresponding points and the second set of remaining corresponding points, and determines a standard deviation from the distances as the objective function. For example, if the first set of remaining corresponding points is represented as “P”, and the second set of remaining corresponding points is represented as “Q”, each set of “P” and “Q” includes a number of “n” points, and the processing module determines a standard deviation of

$$“ {f}_{i} = sqrt ( {\sum }_{j = 1}^{n} ( \vert {P}_{j} - {Q}_{j} \vert \hat{} 2 ) ) ” .$$

as the objective function, wherein the number “i” is an integer starting from “1.” In at least one embodiment, the processing module calculates a conversion relationship between the first set of remaining corresponding points and the second set of remaining corresponding points by using singular values or by using singular value decomposition, and sets the conversion relationship as the least square solution. In at least one embodiment, the processing module obtains the converted first set of remaining corresponding points by multiplying the least square solution and the first set of remaining corresponding points.

At block 250, the processing module determines whether a precision of the objective function is less than the preset precision value. If the precision of the objective function is less than the preset precision value, block 270 is implemented. If the precision of the objective function is greater than or equal to the preset precision value, block 260 is implemented, and block 230 is repeated to execute the iterative method to continuously delete abnormal points from the first set of initial corresponding points and the second set of initial corresponding points. In at least one embodiment, the processing module determines that the precision of the objective function is to be represented as “k=|ƒᵢ−ƒᵢ₋₁|”, wherein “f₀” is preset as “0.”

At block 260, the processing module sets the converted first set of remaining corresponding points and the second set of remaining corresponding points as the first set of initial corresponding points and the second set of initial corresponding points.

In at least one embodiment, before block 260, the processing module one to an iteration number, and determines whether the iteration number is greater than a preset value. The preset value is used for setting a number that the first set of remaining corresponding points can be converted. The preset value is user-determined or predetermined, for example, can be set as 10. If the iteration number is less than or equal to the preset value, block 260 is implemented, and block 230 is repeated to execute the iterative method to continuously delete abnormal points from the first set of initial corresponding points and the second set of initial corresponding points. If the iteration number is greater than the preset value, block 270 is implemented.

At block 270, the processing module joins the converted first set of remaining corresponding points with the second set of remaining corresponding points to form a group of joined point cloud, and outputs the joined point cloud to be displayed on a display screen of the computing device. The joined point cloud is a single coherent point cloud relating to the object.

All of the processes described above can be embodied in, and fully automated via, functional code modules executed by one or more general purpose processors such as the processor. The functional code modules can be stored in any type of non-transitory readable medium or other storage device such as the storage device. Some or all of the methods can alternatively be embodied in specialized hardware. Depending on the embodiment, the non-transitory readable medium can be a hard disk drive, a compact disc, a digital versatile disc, a tape drive, or other storage medium.

The described embodiments are merely examples of implementations, and have been set forth for a clear understanding of the principles of the present disclosure. Variations and modifications can be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. A computing device comprises:
a display screen;
at least one processor; and
a storage device that stores one or more programs which, when executed by the at least one processor, cause the at least one processor to:
acquire a first group of point cloud of an object from the storage device and a second group of point cloud of the object from the storage device;
obtain a first set of initial corresponding points from the first group of point cloud, and obtain a second set of initial corresponding points from the second group of point cloud;
delete, according to a preset rule, abnormal points in the first set of initial corresponding points and the second set of initial corresponding points, and obtain a first set of remaining corresponding points and a second set of remaining corresponding points;
calculate an objective function of the first set of remaining corresponding points and the second set of remaining corresponding points;
calculate a least square solution of the first set of remaining corresponding points and the second set of remaining corresponding points;
convert the first set of remaining corresponding points based on the calculated least square solution;
set the converted first set of remaining corresponding points and the second set of remaining corresponding points as the first set of initial corresponding points and the second set of initial corresponding points, and execute the iterative method to continuously delete abnormal points from the first set of initial corresponding points and the second set of initial corresponding points when the precision of the objective function is greater than or equal to a preset precision value;
join the converted first set of remaining corresponding points with the second set of remaining corresponding points to form a group of joined point cloud when the precision of the objective function is within the preset precision value; and
display the joined point cloud on the display screen.

2. The computing device of claim 1, wherein the first group of point cloud and the second group of point cloud are obtained by:
acquiring corresponding feature points from the first group of point cloud and from the second group of point cloud by using a corner detection algorithm or by extracting boundary characteristic points;
calculating a transition matrix according to the corresponding feature points by using singular values, by using quaternion, or by using singular value decomposition; and
obtaining the first set of initial corresponding points and the second set of initial corresponding points according to the transition matrix and the corresponding feature points.

3. The computing device of claim 1, wherein the preset rule comprises calculating a curvature variation and an angle of normal vectors between each pair of corresponding points in the first set of initial corresponding points and in the second set of initial corresponding points, and deleting a selected pair of corresponding points from the first set of initial corresponding points and the second set of initial corresponding points when a curvature variation between the selected pair of corresponding points is larger than a preset threshold value and an angle of normal vectors between the selected pair of corresponding points is less than a preset angle.

4. The computing device of claim 3, wherein the curvature variation and the angle of normal vectors between a pair of corresponding points are calculated by:
calculating a curvature and a normal vector of each feature point of the pair of the corresponding points based on a covariance matrix of proximal points of the feature point;
calculating the curvature variation between the pair of corresponding points according to the curvature of each feature point of the pair of corresponding points; and
calculating the angle of normal vectors between the pair of corresponding points according to the normal vector of each feature point of the pair of corresponding points.

5. The computing device of claim 1, wherein the objective function of the first set of remaining corresponding points and the second set of remaining corresponding points is calculated by:
calculating distances between the first set of remaining corresponding points and the second set of remaining corresponding points; and
determining a standard deviation from the distances as the objective function.

6. The computing device of claim 1, wherein the converted first set of remaining corresponding points is obtained by:
calculating a conversion relationship between the first set of remaining corresponding points and the second set of remaining corresponding points by using singular values or by using singular value decomposition, and setting the conversion relationship as the least square solution; and
obtaining the converted first set of remaining corresponding points by multiplying the least square solution and the first set of remaining corresponding points.

7. The computing device of claim 1, wherein the at least one processor further:
identifies an overlap area of the joined point cloud where the converted first set of remaining corresponding points does overlap with the second set of remaining corresponding points; and
simplifies and smoothes the overlap area of the joined point cloud by executing preset simplification methods and preset smoothing methods before displaying the joined point cloud on the display screen.

8. A computer-implemented method for joining point cloud using a computing device and executable by at least one processor of the computing device, the method comprising:
acquiring, from a storage device of the computing device, a first group of point cloud of an object and a second group of point cloud of the object;
obtaining a first set of initial corresponding points from the first group of point cloud, and obtaining a second set of initial corresponding points from the second group of point cloud;
deleting, according to a preset rule, abnormal points in the first set of initial corresponding points and the second set of initial corresponding points, and obtaining a first set of remaining corresponding points and a second set of remaining corresponding points;
calculating an objective function of the first set of remaining corresponding points and the second set of remaining corresponding points;
calculating a least square solution of the first set of remaining corresponding points and the second set of remaining corresponding points;
converting the first set of remaining corresponding points based on the calculated least square solution;
setting the converted first set of remaining corresponding points and the second set of remaining corresponding points as the first set of initial corresponding points and the second set of initial corresponding points, and executing the iterative method to continuously delete abnormal points from the first set of initial corresponding points and the second set of initial corresponding points when the precision of the objective function is greater than or equal to a preset precision value;
joining the converted first set of remaining corresponding points with the second set of remaining corresponding points to form a group of joined point cloud when the precision of the objective function is within the preset precision value; and
displaying the joined point cloud on a display screen of the computing device.

9. The method of claim 8, wherein the first group of point cloud and the second group of point cloud are obtained by:
acquiring corresponding feature points from the first group of point cloud and from the second group of point cloud by using a corner detection algorithm or by extracting boundary characteristic points;
calculating a transition matrix according to the corresponding feature points by using singular values, by using quaternion, or by using singular value decomposition; and
obtaining the first set of initial corresponding points and the second set of initial corresponding points according to the transition matrix and the corresponding feature points.

10. The method of claim 8, wherein the preset rule comprises calculating a curvature variation and an angle of normal vectors between each pair of corresponding points in the first set of initial corresponding points and in the second set of initial corresponding points, and deleting a selected pair of corresponding points from the first set of initial corresponding points and the second set of initial corresponding points when a curvature variation between the selected pair of corresponding points is larger than a preset threshold value and an angle of normal vectors between the selected pair of corresponding points is less than a preset angle.

11. The method of claim 10, wherein the curvature variation and the angle of normal vectors between a pair of corresponding points are calculated by:
calculating a curvature and a normal vector of each feature point of the pair of the corresponding points based on a covariance matrix of proximal points of the feature point;
calculating the curvature variation between the pair of corresponding points according to the curvature of each feature point of the pair of corresponding points; and
calculating the angle of normal vectors between the pair of corresponding points according to the normal vector of each feature point of the pair of corresponding points.

12. The method of claim 8, wherein the objective function of the first set of remaining corresponding points and the second set of remaining corresponding points is calculated by:
calculating distances between the first set of remaining corresponding points and the second set of remaining corresponding points; and
determining a standard deviation from the distances as the objective function.

13. The method of claim 8, wherein the converted first set of remaining corresponding points is obtained by:
calculating a conversion relationship between the first set of remaining corresponding points and the second set of remaining corresponding points by using singular values or by using singular value decomposition, and setting the conversion relationship as the least square solution; and
obtaining the converted first set of remaining corresponding points by multiplying the least square solution and the first set of remaining corresponding points.

14. The method of claim 8, further comprising:
identifying an overlap area of the joined point cloud where the converted first set of remaining corresponding points does overlap with the second set of remaining corresponding points; and
simplifying and smoothing the overlap area of the joined point cloud by executing preset simplification methods and preset smoothing methods before displaying the joined point cloud on the display screen.

15. A non-transitory computer-readable medium having stored thereon instructions that, when executed by at least one processor of a computing device, causing the computing device to perform a method for joining point cloud, the method comprises:
acquiring, from a storage device of the computing device, a first group of point cloud of an object and a second group of point cloud of the object;
obtaining a first set of initial corresponding points from the first group of point cloud, and obtaining a second set of initial corresponding points from the second group of point cloud;
deleting, according to a preset rule, abnormal points in the first set of initial corresponding points and the second set of initial corresponding points, and obtaining a first set of remaining corresponding points and a second set of remaining corresponding points;
calculating an objective function of the first set of remaining corresponding points and the second set of remaining corresponding points;
calculating a least square solution of the first set of remaining corresponding points and the second set of remaining corresponding points;
converting the first set of remaining corresponding points based on the calculated least square solution;
setting the converted first set of remaining corresponding points and the second set of remaining corresponding points as the first set of initial corresponding points and the second set of initial corresponding points, and executing the iterative method to continuously delete abnormal points from the first set of initial corresponding points and the second set of initial corresponding points when the precision of the objective function is greater than or equal to a preset precision value;
joining the converted first set of remaining corresponding points with the second set of remaining corresponding points to form a group of joined point cloud when the precision of the objective function is within the preset precision value; and
displaying the joined point cloud on a display screen of the computing device.

16. The non-transitory computer-readable medium of claim 15, wherein the first group of point cloud and the second group of point cloud are obtained by:
acquiring corresponding feature points from the first group of point cloud and from the second group of point cloud by using a corner detection algorithm or by extracting boundary characteristic points;
calculating a transition matrix according to the corresponding feature points by using singular values, by using quaternion, or by using singular value decomposition; and
obtaining the first set of initial corresponding points and the second set of initial corresponding points according to the transition matrix and the corresponding feature points.

17. The non-transitory computer-readable medium of claim 15, wherein the preset rule comprises calculating a curvature variation and an angle of normal vectors between each pair of corresponding points in the first set of initial corresponding points and in the second set of initial corresponding points, and deleting a selected pair of corresponding points from the first set of initial corresponding points and the second set of initial corresponding points when a curvature variation between the selected pair of corresponding points is larger than a preset threshold value and an angle of normal vectors between the selected pair of corresponding points is less than a preset angle.

18. The non-transitory computer-readable medium of claim 17, wherein the curvature variation and the angle of normal vectors between a pair of corresponding points are calculated by:
calculating a curvature and a normal vector of each feature point of the pair of the corresponding points based on a covariance matrix of proximal points of the feature point;
calculating the curvature variation between the pair of corresponding points according to the curvature of each feature point of the pair of corresponding points; and
calculating the angle of normal vectors between the pair of corresponding points according to the normal vector of each feature point of the pair of corresponding points.

19. The non-transitory computer-readable medium of claim 15, wherein the objective function of the first set of remaining corresponding points and the second set of remaining corresponding points is calculated by:
calculating distances between the first set of remaining corresponding points and the second set of remaining corresponding points; and
determining a standard deviation from the distances as the objective function.

20. The non-transitory computer-readable medium of claim 15, wherein the converted first set of remaining corresponding points is obtained by:
calculating a conversion relationship between the first set of remaining corresponding points and the second set of remaining corresponding points by using singular values or by using singular value decomposition, and setting the conversion relationship as the least square solution; and
obtaining the converted first set of remaining corresponding points by multiplying the least square solution and the first set of remaining corresponding points.
